(19) United States
(12) Patent Application Publication
(10) Pub. No.: US 2018/0357651 A1
(43) Pub. Date: Dec. 13, 2018

(54) SYSTEM FOR MARKETING GOODS AND SERVICES UTILIZING COMPUTERIZED CENTRAL AND REMOTE FACILITIES

(71) Applicant: Stephen Corey Wren, Marshall, TX (US)

(72) Inventor: Stephen Corey Wren, Marshall, TX (US)

(21) Appl. No.: 15/618,346

(22) Filed: Jun. 9, 2017

(51) Int. Cl. G06Q 30/02; G06Q 40/08

(52) U.S. Cl. CPC G06Q 30/0201; G06Q 40/08

(57) ABSTRACT

A system for shopping for goods and services includes computerized central communications facilities (central facilities) and computerized remote communications facilities (remote facilities) connected by a communications network(s), and means permitting data communications between them. Central facilities offer goods and services, some in competition with each other, and store in addition to data, video such as graphics and images, and audio such as voice and music. An input device(s) for each remote facility permits customers to access the data, video, and audio. Communications devices for each remote facility also enable that facility to receive and download the data, video, and audio. Remote facilities are adapted to enable a customer, after viewing the data, video, and audio, to select their purchase and remit payment. Central facilities can generate and transmit to the remote facility transaction specific documentation relative to the purchase so executed.

### CROSS REFERENCE TO RELATED APPLICATIONS

This application is a continuation of copending U.S. application Ser. No. 14/025,576, filed Sep. 12, 2013. This application claims the filing date priority of it and all related applications, including but not limited to . . .

1. Disclosure Document #303549, fld Mar. 13, 1992

2. Ser. No. 07/855,099, fld Mar. 20, 1992

3. Ser. No. 08/051,743, fld Apr. 22, 1993

4. Ser. No. 08/264,184, fld Jun. 22, 1994

5. Ser. No. 08/268,309, fld Jun. 29, 1994

6. Ser. No. 08/650,834, fld May 20, 1996

7. Ser. No. 08/668,561, fld Jun. 21, 1996

8. Ser. No. 09/504,374, fld Feb. 15, 2000

9. Provisional 60/311,819, fld Aug. 14, 2001

10. Ser. No. 10/217,643, fld Aug. 14, 2002

11. Ser. No. 11/894,000, fld Aug. 17, 2007

12. Ser. No. 12/124,027, fld May 20, 2008

13. Ser. No. 12/556,353, fld Sep. 9, 2009

All of which are incorporated herein by reference.

Applicant reserves all rights and waives none such as in respect to all claims previously filed in any related case, including the right to further file, prosecute and appeal to the courts at any later date, any claim previously filed or contemplated in any related application without prejudice, waiver, or disclaimer to the subject matter claimed therein.

The Applicant has in this application used the specification of related application Ser. No. 11/894,000, a prior application in the chain which was incorporated by reference in all subsequent applications, including the copending application from which this instant continues.

The Applicant also cites the IDS filed Dec. 17, 2014 in the 576 parent application that it, all Examiner cited references in that case, all related cases cited above and any others be considered in this application for the purpose of potential prior art.

### FIELD OF THE INVENTION

The present invention generally relates to a system for marketing goods and services utilizing computerized central and remote communications facilities (hereafter simply referred to as central or remote facilities), each such facility being a collection of electronic computing and communications equipment used to implement an embodiment of the invention. Specifically, this invention relates to a system and means embodying a communications link between central and remote facilities and utilizing electronic communications devices and computing equipment for selling and marketing goods and services and facilitating their transactions.

Over the years the marketing of goods and services has increasingly been hindered by problems experienced with conventional systems and methods. The more serious of these problems are high administrative costs, long delays in creating and bringing new products to market, and complex practices which confound and confuse retailers, agents, and customers.

The traditional approach in marketing financial services products, for example, has been to offer them at retail sales locations by employees of the retail businesses acting as agents of the financial services companies. One of the consequences of this approach is that each retail sales business is required to have the necessary means for calculating or computing and quoting rather complicated matters, such as payments and premiums, and to be responsible for maintaining computer hardware and software systems independently of and in addition to that at the financial services companies. All too frequently these requirements result in contracts written with wrong amounts and/or terms which later create embarrassment and confusion for the retail sales business when those contracts have to be amended, endorsed, or worse yet completely rejected. Such systems in the field generally limit the use of a given customer facility to a single provider.

An ideal system would utilize central and remote facilities working together to overcome such problems. Such systems have been tried, but they have not been totally satisfactory.

The prior patent art reveals one remote transaction system whose stated objective is to “perform desired transactional services”. That is the system disclosed in U.S. Pat. No. 5,347,632 to Filepp et al. This remote transaction system should be considered as a possible candidate for offering solutions to the aforementioned problems experienced with the traditional approach of selling and marketing goods and services.

However, Filepp suffers from at least 2 substantial weaknesses. One is the manner in which his system is configured and performs (see FIGS. 2 and 3 for a comparison). In Filepp, as is understood, each user/customer computer or RS 400 stores all information to be provided the customer and is linked in a network (301) with his regional computer or cache/concentrator 302 which serves up any information requested by the customer which is not already stored on his computer. The regional computer is linked in a separate network (201) with the central computer or file server 205. Any information requested not already on the regional computer is retrieved from the central computer by the customer's regional computer via network 201, then relayed to the customer computer over network 301.

One substantial problem with this structure and configuration as in the traditional financial services model described above, is this requires the duplication of the same information throughout Filepp's system requiring all information to be stored on the central, regional and user computer before the user may obtain it. But this will require significantly greater use of his system resources (networks, computers, storage, etc) and a more elaborate system than with embodiments of this invention where product information is stored with a central facility which any user may contact to obtain the desired information. This inventor has thus streamlined the need to store desired information on multiple regional or central computers and the potential for outdated or incorrect information with more efficient use of system resources by completely reconfiguring the network and reshuffling its components or apparatuses—reducing bottlenecks and streamlining efficiency in such systems, thereby creating a new and improved way to use computer networks in selling and marketing financial services and all other good and services. In this manner the inventor has taken the previously closed network and architecture of digital processing or computer components of such systems and reconfigured into an open architecture system allowing far greater reliability, efficiency and choice.

Another crucial weakness of Filepp is that in his system there is only one provider of information, products and services, whereas in embodiments of this invention there are many as various embodiments of this system have been reconfigured in a manner which will allow users to select and contact central facilities of multiple providers. This inventor has thus rejected the monopolistic one to one configuration of Filepp and provided users with an unconventional arrangement in a many to one system and with it competition for their business, offering them a far greater selection of goods and services and at lower prices and simplifying the task and improving the reliability of storing and serving up the information on those products and services to users.

There have been other forerunners of these types of systems. One of the first to use central and remote facilities was Lockwood in U.S. Pat. No. 4,567,359.

By Lockwood, as understood, each remote terminal was programmed or configured to elicit information in a predetermined sequence from a customer, and to transmit that information to a central processing center. This was done in a fashion similar to a programmed course. Lockwood obtained the required information by means of simulated interviews with a fictitious agent created by audio-visual devices. The information obtained was merely input for use in Lockwood's program, and the customer had no latitude. Using that approach a customer was asked pertinent questions in order to learn the type of insurance desired and other information necessary to process a quote.

In Lockwood, at a central terminal the information was processed and the results were transmitted back to the remote terminal. The customer was then given an opportunity to select a policy or take it home for study. These were his only options. In Lockwood then the customer terminal was there for the purpose of satisfying the central processing center, and not for assisting the customer.

In U.S. Pat. No. 5,231,571 D'Agostino referred to Lockwood, and rejected the Lockwood method because the customer had no say, pointing out that Lockwood's remote computers greatly reduced labor costs, but the reduction of such costs was at the expense of completely removing the human interface. To overcome this problem, as understood, D'Agostino provided a computerized system which included a personal representative, or financial assistant, at a central terminal. Each customer terminal stored all financial information, as understood, and a display was provided at each of those terminals so that the central representative could display selected information for the customer to view. Thus, a central terminal was linked to a customer terminal, but the display, and all of the information at the customer terminal, were controlled at the central terminal. The output was controlled by a representative at the central terminal in response to one-on-one conversations between the customer and the representative. The customer had no access to a computer, and D'Agostino did not want him to. The customer was to converse and not use a terminal. Neither Lockwood nor D'Agostino, then, adequately solved the problems existing between remote and central facilities where used for selling and marketing goods and services.

In U.S. Pat. No. 4,992,940 Dworkin also dealt with the use of remote and central facilities, providing a remote system for locating the best available prices for products or services. As understood, for the remote facility Dworkin used a series of screens, tests and templates designed to elicit the desires of a customer. The customer selected options in multiple choice fashion or filled in blanks in templates. When the series was completed the customer's desires relative to goods, their sources and prices, was to have been obtained for use at the central facility. The resulting information generated by the central facility for the customer was then transmitted back to the customer.

Another remote transaction system, disclosed in U.S. Pat. No. 4,845,636 to Walker, provided a transaction booth located remotely from an operations center. It was used for facilitating such transactions as renting automobiles. As understood, the booth and center were connected by audio and video equipment used for transmitting audio and video signals from the customer in the booth to the agent at the operations center in order to negotiate a transaction. The customer in this instance knew what he wanted. He was not shopping, but merely seeking to effect a predetermined transaction.

A review of the prior art shows that all of these systems fall short, in part for various reasons as explained above. Another is because none take all types of customer personalities into consideration. In the course of several years of teaching computer classes this inventor developed a theory regarding human interaction with computers which was partially the basis for the system provided herein. From my observations of students I found that there were three classifications of human attitudes toward the use of computers. The first group preferred to be left alone when using computers and wanted to work things out on their own. This group tended to be very independent and to them unrequested assistance, such as from a representative, was an intrusion. This independent group needed an input device operating in a self-service mode.

A second group wanted to be told what they needed to do, and thereafter would help themselves. This dependent group needed the assistance of a live attendant in conjunction with an input device. Such customers, thereafter, would help themselves.

A third group of students wanted to be shown what to do every step of the way. This group wanted to be allowed to sit back and passively watch whatever was being presented. This passive group required a live attendant who could take control of the system.

It is to be appreciated that none of the references discussed hereinbefore satisfy all types of customers. The invention herein takes all three types of customers, the passive, the dependent, and the independent customers into consideration, and provides a system that any of the three can use. This is not true of the prior art, even when combined.

Consequently, a need still exists for new and improved systems utilizing central and remote facilities with more latitude and fewer limitations in shopping for goods and services, or for engaging in business transactions. Such a system and means are provided herein.

### SUMMARY OF THE INVENTION

An improved system for providing these financial services, and in general all goods and services is one which overcomes the above-described problems of the traditional approach. Such system will employ the qualified agents or available representatives of the central facility and its centrally located computer hardware, software or instructions, and product information (comprising all desirable product information) and is thereby configured to generate any appropriate documents tailored to the particular customer while reducing or eliminating the necessity to obtain and maintain any instructional manuals and application forms necessary for carrying out of these activities at each remote facility.

In the present invention it is contemplated that customers can use the remote facility to contact multiple central facilities—each a provider of goods and services. An advantage is the greater number and selection of goods and services available to customers, providing greater variety of products and a lower cost. This method also as above improves the competition for the products offered at the remote location and includes the use of what might be described as full motion commercials.

The present invention in one embodiment furthermore integrates the sale of financing and insurance within the system and provides the user, customer, or person at the remote facility a means of input.

The present invention in one embodiment is an apparatus for marketing goods and services which comprises:

A central facility to provide information relating to goods and services to a customer at a remote facility.

The customer is able to select at least one other central communications facility providing information relating to goods and services.

Equipment is provided permitting the central communications facility to communicate with the remote facility, including transmitting product information to the remote facility.

The central communications facility stores a database(s) or file(s) of information relating to goods and services which the customer at the remote facility can search, browse, and/or access.

This invention is generally concerned with a system and means for concurrently or nonconcurrently transmitting voice, music, audio, data, images, video, and optic information on goods and services, and/or signals—some or all of which may be compressed. It embodies a communicating link between central and remote facilities and utilizing electronic communications devices and computing equipment for selling and marketing goods and services and facilitating transactions. Such systems will be used to market, sell, finance, and insure goods and/or services. The system for marketing goods and services herein includes a remote facility, a central facility remote therefrom, and a data link between them. This invention in one embodiment includes:

computer means at both the remote and central facilities, adapted to transmit and receive images, audio and data between them; means for additionally establishing voice contact between the two communications facilities; stored software of the central computerized communications facility adapted to provide goods and services information; input means at the customer computerized communications facility adapted to enable a customer to access that software in order to view a presentation adapted to educate the customer about the goods and services; input means adapted to enable a customer to access the software in order to bypass the presentation, and, in a self-service mode, to browse in the software to view desired information to learn about goods and services at his desired level of knowledge; means enabling customers at any time they desire personal assistance to utilize the means establishing voice contact to talk to a representative for the central computerized communications facility; application software of the central computerized communications facility enabling customers to download from the central facility to the customer computerized communications facility information desired by the customer; and input means located at the customer computerized communications facility enabling the customer to access application software of the central computerized communications facility.

Further, in one embodiment the information regarding the goods and services obtained by the customer may include accompanying voice narration.

The input means at the customer computerized facility and the application software of the central computerized facility in one embodiment enable customers to search for goods according to model, manufacturer, and marketer of the goods.

The input means at the customer computerized facility and the application software of the central computerized facility in one embodiment enable customers to search for a selection of goods and services.

The application software of the central computerized facility in one embodiment enables the customer to download instruments finalizing a transaction relative to the goods and services.

To correct earlier failures of predecessors, the present invention in one embodiment uses the computing devices to transmit presentations of goods and services including text, graphics, voice, audio, music, images, and video.

The use of computerized voice is significant. The prior art is limited generally to transmitting only text and perhaps a few graphics, requiring that the customer read a great amount of text to get the information they wanted. In contrast, the system of the present invention understands these preferences and has adjusted the system accordingly to accommodate the present generation.

A disadvantage of text is its limited ability to convey enthusiasm, emotion, and in general meaning. There is much contained in human speech in terms of inflection, tone, and volume which convey a significant part of the idea intended. Consider that a particular sentence can when spoken one way be a compliment, yet when spoken with different inflection it becomes an insult. As illustrated, text seldom conveys these colorful aspects of speech and can never succinctly convey a complex thought or idea entirely. Even worse results can be obtained when translating from one language to another. Text only approximates speech. It does not replace it as the forerunners of these systems assumed.

This invention in one embodiment provides a system where customers can shop for homes and obtain financing all in one place. Customers may shop from computer stores, homes, factories, office buildings, and from all public and private locations from which consumers or customers want to obtain product information or perform a transaction. The customer's use can be personal or for business, such as where he seeks to acquire goods or services for a business rather than for himself.

### BRIEF DESCRIPTION OF THE DRAWINGS

In the following detailed description, reference will be made to the attached drawing in which:

FIG. 1 is a block diagram of an array of electronic communications components employed in a system and method for facilitating transactions in accordance with the principles of one embodiment of the invention.

FIGS. 2 and 3 are block diagrams of the Wren and Filepp systems, for comparison, as discussed in the below ‘Field of the invention’ section.

### DETAILED DESCRIPTION OF THE INVENTION

One embodiment of a system 10 and method for facilitating transactions in accordance with the principles of the present invention will now be described in detail. The transactions facilitating system 10 includes at least one central facility 12, such as a financial services company, marketer, or manufacturer and at least one remote facility 14, such as a retail sales facility, or any other public or private location from which a potential customer of the central facility 12 wants assistance in facilitating a transaction. For instance, the remote facility 14 can be a car, truck, boat or motorcycle dealership, department store, public location such as a shopping mall, auction house, airport, grocery store, or real estate office. The central facility 12 can be a financial services facility, such as a bank, credit union or a finance company or any other central facility from which a customer wants assistance in facilitating a transaction.

In the illustrated case of financial services, the system 10 in one embodiment facilitates the carrying out of activities such as financial business transactions in accordance with the principles of the present invention by employing an array of means for transmitting and/or receiving information comprising visual, audio, and/or data between the central facility 12 and a customer using a remote facility 14. The financial services company offering the goods and/or services or assistance in facilitating such a transaction may be at a central location. Each retail sales or remote facility 14 is sited at a given remote location where potential customers are located whether stationary or portable. In this respect the system can be used to execute a transaction between the customer and the central facility or it can only provide assistance to the customer in his selection of goods and services which a local or remote facility are to thereafter provide.

At the remote retail sales facility 14 an area is established where an array of electronic communications and computing equipment is provided in accordance with one embodiment for transmitting and/or receiving information comprising visual, audio, and data about financial services or other goods and services between the central facility 12 and the customer at the remote facility 14.

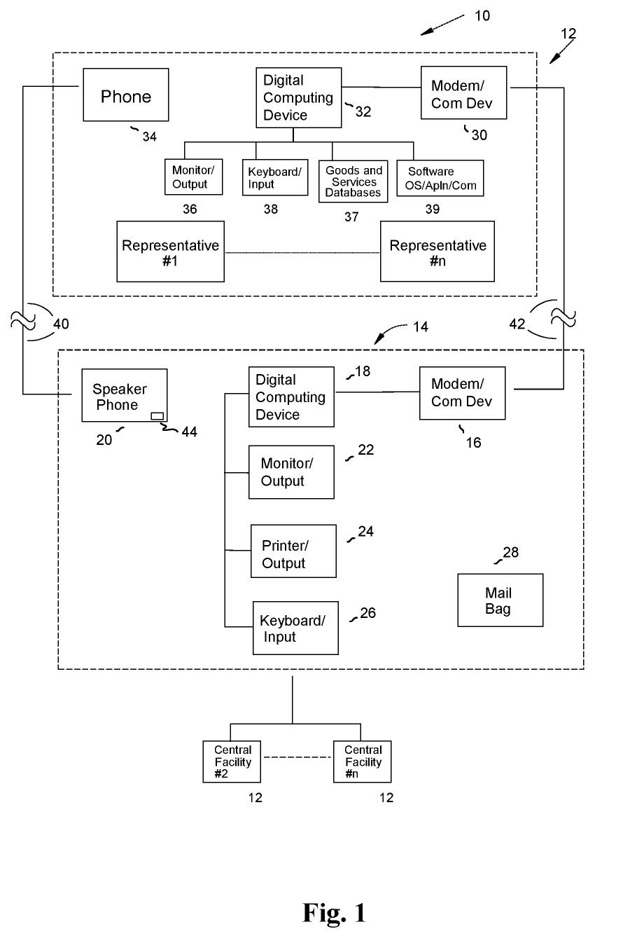

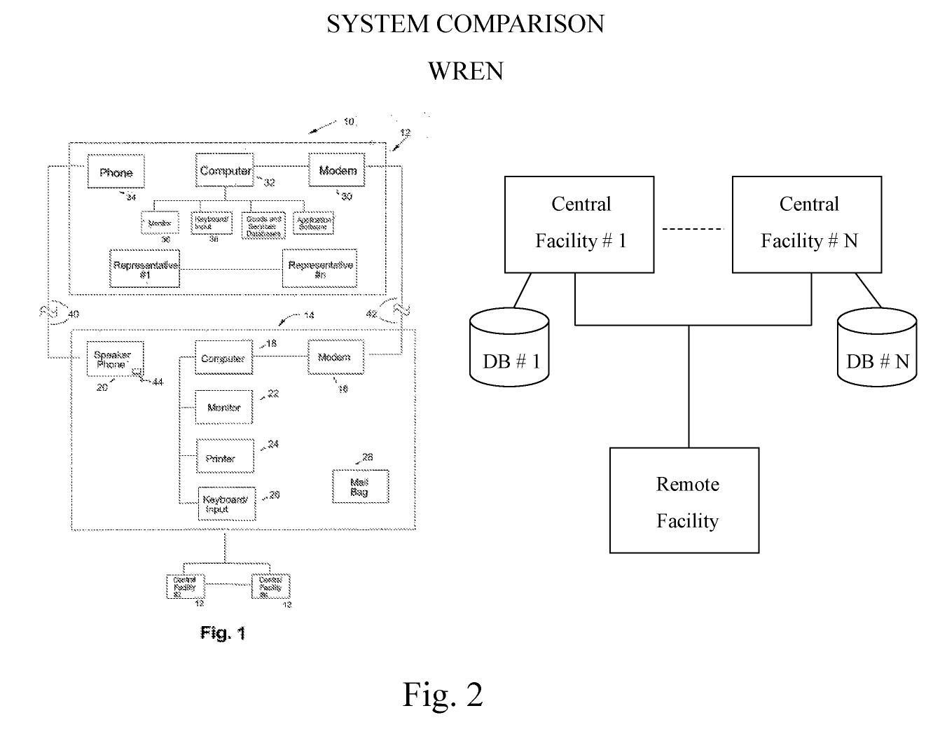

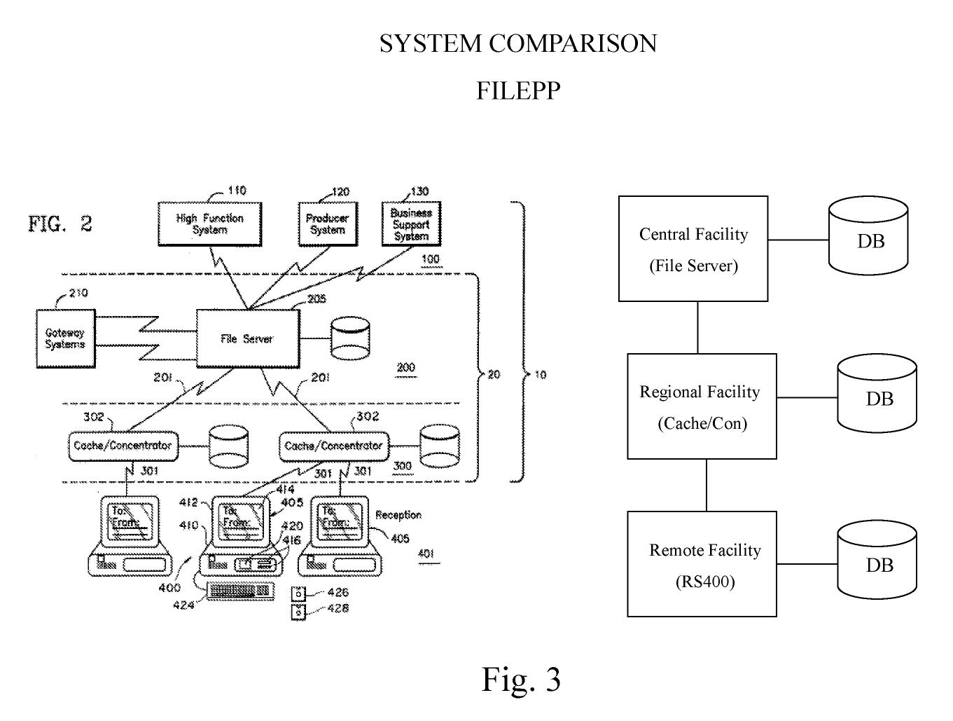

More particularly, as seen in FIG. 1, such an array of electronic communications devices and computing equipment of the remote facility 14 includes a modem or network communications device 16, a digital computing device 18, which includes a central processing unit with internal (memory) and external storage, a speaker phone 20 perhaps with separate external speakers or other means of conveying sounds, output devices such as a monitor or display device 22 or other means of conveying images, a printer 24 or other means for recording signals or information conveyed from the central facility 12, input devices such as a keyboard and/or mouse 26, and instructions or software such as operating system, application, and communications. It is anticipated that a handset rather than a speaker phone or external speaker can be used in instances where a customer wishes to speak privately with a representative.

For an application of this system in homes the input device could be a television remote control device perhaps with alterations comprising cursor movement keys, a joystick, or a microphone for voice input. In recording this product information the customer can then save or take the desired information with him for his later review which might comprise instructions for use, operation, or assembly and can include a list of suggested products or services as advised by the live representative or by the central facility computer. Such information might be recorded on paper, magnetically such as upon a cassette, video tape, computer disc, CD, or a chip embedded or smart card, or by some other means. Comparably the central facility can record the transaction for later retrieval so the customer can continue where he left off at a later date should his interest renew or for identification purposes or for possible assistance in resolving disputes. Other means to verify identification of the customer can be used comprising magnetically encoded badges or cards. Additionally, a mail bag 28 or other means for remitting payment or documents is provided at the remote facility 14.

For communicating with the customer at the remote facility 14, the central facility 12 includes a complementary array of electronic communications devices and computing equipment. As seen in FIG. 1, this equipment includes a modem 30 or network communications device, a digital computing device 32 which includes a central processing unit with external and internal storage or other means for processing information, instructions or data; a phone 34 or other means for voice exchange or audio transmission, output devices such as a monitor 36, input devices such as a keyboard, voice input and/or mouse 38, and software such as operating system, application, and communications 39. The central facility also includes one or more databases or files of goods and/or services 37. Only a complementary printer is not needed for the central facility 12 for the purpose of facilitating transactions in accordance with this embodiment of the invention. A communications network links the remote and central facilities such as by two separate phone lines 40, 42 to interconnect the respective phones 20, 34 of the facilities 14 and 12 simultaneously with, but separately from, the interconnection of the respective modems 16, 30 of the facilities 14, 12 so that voice and data communications can be ongoing concurrently between the customer at the remote facility 14 and an agent for the central facility 12. Alternatively, such contact can be established by coaxial cable such as through a cable company or some other means of establishing contact or by means of some wireless technology such as radio. Each of these components of the respective electronics communications equipment at or for the respective facilities 12, 14 is per se a conventional off-the-shelf item and thus it is not necessary to describe such components in any further detail.

One embodiment could use a combination of wired and wireless technologies. In this instance the information being transmitted to the customer could be on a wireless basis whereas the signals transmitted to the central facility could be on a wired basis. The advantage of this approach is that standard telephone lines can be insufficient at transmitting extensive amounts of video and audio information. However, the bulk of this type of transmitting will in certain cases be going from the central facility to the customer. But in many instances the demand for transmitting from the customer to the central will be significantly less and will in most cases be adequately handled by normal telephone lines. This approach can then reduce the expense of deploying these systems by reducing or eliminating the need to install a more advanced wired communications network.

At the remote facility 14, in one embodiment the customer of the retail sales facility 14 and/or of the financial services facility 12, is escorted to the area where the above-described array of electronics communications equipment of the retail sales facility 14 is provided. The customer presses an auto dial button 44 on the speaker phone 20 or uses his input device such as a touch screen to select a central facility to contact from a list displayed on his monitor and in doing so establishes contact with the financial services company 12 and perhaps its agent by way of some means of transmitting data, audio, and/or visual information thus permitting the simultaneous or concurrent transmitting of audio, video, and data as the customer and representative speak with one another or establish voice contact and while the representative provides the customer with information about goods and/or services. At that time the customer can automatically review established presentations to better prepare him for a session with a representative and to educate the customer on the goods and services he is about to consider or at the customer's wish he can bypass these introductory presentations and immediately direct the session or request personal assistance from a representative. As an alternative, the customer can establish contact with the central facility's equipment without the assistance of a representative and merely help himself in a self-service mode where he can browse through databases or files of goods and services. The speaker phone 20 as contemplated herein is intended to encompass other comparable devices, such as a videophone or the like, where in addition to 2-way verbal contact the customer can establish 2-way or 1-way visual contact with the agent. Concurrently or subsequently the remote facility can transmit its phone number, serial number, or identification code to the central facility so as to identify itself and thus satisfy any future administrative needs of the central facility should for example a break in communications occur and the need arise to reestablish contact with the specific remote facility and its customer. In this respect it will be necessary for each remote facility to store this serial, phone, or station identification number for future transmittal.

While in one embodiment of the invention the customer at the remote facility initiates contact with the central facility it is contemplated that the central facility or its representative can have occasion to initiate contact with a given remote facility. An example is a public or private location where the central system contacts the remote facility to apprise potential customers of goods and services offered. In a public location such as at a mall a remote terminal can perform for customers who pass and prompt them to press the screen to obtain specific information.

In contacting customers firms may in one embodiment distribute samples such as for entertainment products (music, movies, sports . . . ), publishing (books, magazines, newspapers . . . ), other goods or services that may be so transmitted such as software, or vouchers to collect as samples other goods or services at regional locations.

To facilitate reconnection in one embodiment should an accidental break occur in the connection between remote and central facilities, upon each break initiated by a customer a control signal will be transmitted to the central facility. Otherwise should any break occur without the central facility having just prior received this code the central facility will know to reestablish contact. If the code is received just before the break there will be no need to reconnect as the customer terminated contact. Another approach is to store the presentation stopping point at the remote facility so that if accidental break occurs it can reinitiate contact if the customer wishes.

Having established contact the customer and agent then speak with one another by way of the phones 20, 34 of the respective facilities 14, 12. Concurrently, the agent by using his or her digital computer 32, monitor 36, keyboard 38 or other input device and modem 30 establishes electronic contact with the customer's modem 16, digital computer 18, monitor 22 and printer 24 if such contact has not already been established by the customer by means of a single telephone or communications line, or wireless means to transmit and provide helpful audio, video, and data information to the customer about the transaction being proposed for the customer by the financial services facility 12. Such information can take the form of charts and the like displayed on the monitor 22 or printed on a sheet of paper by the printer 24. It can comprise audio and visual information related to those goods and services of interest to the customer and can contain any desired sales or product information such as product specifications, service data, published articles, product demonstrations, orchestrated presentations, sales literature such as you might find in a brochure or catalogue, possible uses, compatibility, styles, selection, availability, comparisons to other products or services, published articles on products or services; product features, compatibility, or requirements.

In the case of financial instruments or investments, information might comprise expected profit or margins, past performance of like products, maturity dates, terms, conditions, exclusions, limitations, and exceptions. In the case of automobiles or other durable goods information might comprise models, styles, expected life, efficiencies, colors, capacities, maintenance requirements, options, comparisons between models, published articles on products or excerpts of, pictures of products (still and full motion of product as in its various uses), testimonials of products, commercials, or infomercials. Information for home users when purchasing or renting movies, music, or other forms of entertainment might comprise: ratings, titles, product descriptions, artists or actors, articles written by critics or excerpts of, short segments of music or movie (samples or previews), lists of products available and in general any audio or visual information a customer might wish to know including quote, price, or any information about goods or services other than quote, binder, or price. While watching entertainment customers may pause their viewing or participation and request information on products related to or advertised therein. In the case of sporting events customers may pause or interrupt to obtain information or statistics on a team, player, coach or team licensed products or services.

In its use of samples, providers may use the system to distribute samples of their goods or services. Such products would comprise entertainment (as in movies, music, sports . . . ), publishing (books, magazines, newspapers . . . ), other goods that may be so transmitted such as software, or vouchers to collect as samples other goods or services. Providers may initiate contact with customers in their distribution or they may transmit said samples in response to a customer request.

As an assistance to any attendant or representative for the central facility that same or related product information can be displayed on the representative's monitor of the central facility to aid in his assisting the customer.

The digital computer 18 stores suitable well-known off-the-shelf operations, communications and perhaps graphics software programs in its memory and is thereby operational, programmed or configured to translate the signals, electronic or otherwise, caused to be transmitted from the financial services facility 12 into such displayed, audio reproduced, recorded, or printed information. An example of a suitable communications program is one commercially available under the trademark Carbon Copy thus permitting or enabling the representative to control the equipment at the remote facility and permitting the customer to retrieve and access information about goods and services stored for the central facility. An example of a suitable graphics program is one commercially available under the trademark Harvard Graphics which can be used to reconstruct digitally transmitted information back into visual images.

Thus, the agent residing at or for the central financial services company 12 has the ability to control the above-described electronic communications equipment in the presence of the customer located at the remote facility 14. The agent is thereby able for example to display any desired information at will on the customer's monitor 22 or to print any information at will on the customer's printer 24. The customer can respond verbally to central facility prompts initiated by the representative or the central facility equipment via the speaker phone 20 or by using his or her keyboard 26 or other input device or some other means to convey customer supplied information. Such an input device is anticipated to comprise a touch screen permitting the customer to press a screen displayed icon to supply his choices or input, and voice activated response or voice recognition input permitting him to speak his responses, selections, or data input. Personal data to be supplied by the customer can be voice input or supplied by other appropriate means comprising retrieved from a personal data card supplied by the customer by means of a magnetic reader or other comparable device capable of retrieving information thus stored and the system can then permit the customer to update or correct any information provided. The system can also utilize voice synthesis to prompt or present options to the customer and can be used in tandem with visual prompts.

In this fashion the customer can at his leisure and without the assistance of the representative review any desired information about those goods and services he is most interested in with complete privacy yet can by way of his input device request a representative at his will should he desire personal service. He or she can then serve himself should he wish or if preferred he can sit back and let the representative fully control the presentation. The transmitted presentation can utilize a well known spokesperson and give the appearance of a commercial or infomercial. On his own the customer can control the sequence of the presentation. That is to say he can back up, fast forward, skip, or jump to the specific product information he wishes at his command. To aid the customer in locating desired portions of a presentation, the audio visual information can be encoded with text or other keys permitting the customer to search and browse by subject or keyword. The system also includes the ability to zoom in. The customer can enlarge part of the screen to study specific information or details, adjust volume or other attributes of audio, pause, or jump to a next layer to get more specific details. His access to this information is described in the computer industry as random. Information can be provided at various levels of detail through a technique known as hypertext. The customer can thus review a summary of specific information and at his request or command receive a level of information of greater detail. One such method of accomplishing the summoning of the representative is to provide an icon or tool on the customer's monitor which he can press or select at any time which in turn causes the system to summon or ring a centrally or alternatively remotely located representative to personally assist the customer.

In a related embodiment, the system may contain a multilayer navigation system, perhaps novice and expert levels. The novice level would offer limited options and control and might be compared to driving an economy car while the expert level could be compared to a sports car or jet. All new subscribers or users would begin at the novice level and could proceed to the expert level at their own pace. Perhaps each time the user logs on a new feature would be introduced or he would have the option of having it introduced so that gradually the customer might progress to an expert level. Of course all the while the customer may ring for an attendant if he wants assistance.

Additionally a security feature could be installed to protect customers or the remote facility from vandalism where placed in public locations. Here the user is required to present his credit card or other ID to obtain entry into a locked facility containing the terminal.

Another approach to guard against vandalism of publicly placed equipment is to have a live attendant greet on screen each customer as they approach the system who could then explain how to request live assistance should the customer have a later need. Alternatively, a camera could be placed on each system to monitor the customer's use and a notice could be posted about the use of the camera to protect the customer's availability to the system. An alarm can also be used that is activated automatically under certain conditions or manually by the rep for the central facility.

In providing the customer an input means we have permitted greater utilization of the representative's time and allowed the customer to only be assisted as he wishes. However, the system can monitor the customer's activity to signal when an appropriate time might be for the representative to voluntarily offer assistance should the customer become confused or lost. An application of a computer technique referred to as artificial intelligence will help identify the occurrence. Such a situation is indicated by a customer's repeated review of the same information or lack of command to the system within a given period of time.

When appropriate the agent can then command the customer's printer 24 to create or print needed contracts and documents (comprising loan application papers, a notice of proposed insurance, an insurance binder, an insurance application, receipts, etc.). The agent can also display his or her own image in a corner of the customer's monitor 22 as a courtesy by using an appropriate communications program and a graphics file produced from the agent's photograph with a conventional image scanner.

In combination with the application for a loan or the presentment of a credit card or some other payment instrument the central facility perhaps under the direction of the representative or under control of the central facility's application software can initiate a credit check to determine the customer's credit worthiness or qualify the customer so as to approve the intended purchase. The central facility can itself store credit or check approval information for each prospective customer or can communicate with a third party such as TRW and exchange appropriate and necessary information on the customer while the customer waits at the remote facility to obtain the necessary credit history in order to process and approve the customer's request. Should the result of the check be negative, the representative can converse with the customer to perhaps arrange for alternate means of payment. Having qualified the customer the central facility can in the event of a loan request conduct the necessary risk evaluation, manually or electronically by means of algorithms to determine loan approval. A similar approach can be taken for insurance requests. The customer can respond to questions regarding his medical history and based upon a search of medical history either with the central facility or at a third party such as the Medical Information Bureau determine the insurability of the customer and insurance approval.

While in one embodiment of the invention the final approval for loan or insurance is made upon the customer remitting completed forms either electronically or by mail or some other means, it should be understood that having performed the necessary medical or credit check the central facility can immediately approve the customer's application or request for insurance or credit and commit itself. During the solicitation process the central facility can record and store the presentation such as to meet regulatory requirements for proof of disclosure as when selling insurance, loans, or investment instruments comprising stocks, bonds, annuities, and mutual funds.

Once the contracts are printed out the customer is directed to sign them and personally place them and any required payment (check) in a mail bag 28 located at the retail sales facility 14. A binder can be issued upon the customer signing applications for financial services and mailing them so he can take possession of any purchased goods or merchandise in contemplation of the financial services companies accepting the applications and performing final execution of the contracts in the home sovereign.

In the application of entertainment the possession can include the presentment of recorded performances or programming to the customer such as can be transmitted or in some otherwise fashion conveyed to the customer.

Alternatively, some other means of remitting payment and any completed contracts to the agent can be used such as electronically where the customer can for example endorse an electronic signature box displayed on his monitor by means of an electronic pen or other comparable device and subsequently transmit by modem the electronic contracts back to the central facility or by some other electronic means to permit the customer to legally apply for contracts perhaps comprising the faxing or transmitting of a signed contract from the remote to the central facility.

At the end of a session the system can prompt the customer for comments or take a poll. The customer can respond with his input device. The system can also encourage the customer to speak into a microphone to record the customer's comments on products, assistance provided by a live rep, or the system itself. The advantage in recording the customer's verbal response is that the easier it is for customers to respond the more likely they will. Also, open-ended questions that can be very revealing are difficult to obtain if the customer is required to hand write or type comments. Recording the response will make the best use of the customer's time and improve the success of obtaining this information. As a mechanism for requesting this information the system could list an OFF button. Once a customer has selected OFF the system can begin to execute a closing procedure which could include a customer questionnaire.

At some point during the customer's session the system can prompt them for their address, or contact information comprising phone number, mailing address, system address or other means of contacting customer so as to forward additional or updated product information to them perhaps regarding future special offers. This approach introduces a whole new method to sales promotions. Along these lines, while on the system a customer can receive a bulletin of for example product or public service information permitting the customer to if desired request more specific information by input means. In one embodiment, once a customer has selected and paid for their purchase those products that can not be delivered on the spot (such as via a remote printer or other device permitting the culmination of a transaction) can be delivered to the customer such as at their residence or place of business. Alternatively, customers can pick up their purchases at a central order processing center.

Another embodiment provides for team shopping permitting group customers at the same or different locations to view the same presentation simultaneously under the control of one of the customers as they speak with each other. In this instance a customer at the same or different remote location will assume control of the input device for one or more different customers. Control of the system can alternate between the individuals so that at times a first customer can control the presentation while at another time a second or other customer can assume control. The selected information will be presented to each shopper in the party though they can be at different customer locations. In this way each person in the group can share with the others products they find interesting. At the same time they can all engage in a group conversation or perhaps video conference so each can hear the other as they review the presentations together.

The advantage of this approach is that historically electronic systems have failed to captivate certain segments of the population such as females. Part of the problem is that the act of using such a system has to this point been a solitary activity. While some customers can be content using the system by themselves, others are more group oriented and prefer social contact. For example, while some people (perhaps men) will be more inclined to visit a store or go shopping by themselves, others (perhaps women) are more likely to be accompanied by a friend. This embodiment of the system then recognizes these differences between customers and allows those who are more group oriented to use the system in a way they are comfortable with.

Another use of the system is to create electronic cities. Here the system creates a tour to guide electronic tourists through a selected city showing important points of interest as presented by an electronic version of a tour guide with verbal narration. Customers are allowed to browse and shop on their own at anytime. Using the system in this way customers are able to electronically sightsee and shop at a selection of cities within their country and internationally. The ability to tie in the flavor and charm of a city or country with its products should greatly encourage customers to shop and make the customer's experience fascinating. Cities and countries could introduce themselves in a positive way and encourage tourism. The system's use in this fashion allows it to disseminate knowledge of a region and its people to others helping to improve relations between cities and countries.

Another version of the invention utilizes a full blown video conference center providing a large screen, perhaps wall sized, 2 way color video and audio device in addition to a remote printer used to generate or print documents for the prospective customer. In this fashion the customer is placed in a theater like environment so he can comfortably view any desired product information by means of full motion, full color, audio/visual presentations. Images can be displayed by holograms or similar 3 dimensional means to give life and form to goods or services sold.

Alternatively the video can be 1 way or nonreciprocal versus 2 way or reciprocal should the customer prefer to not be on camera. It can as well be monochrome as opposed to color where preferable such as when communications resources are not available to achieve full color video. To put the customer at ease at the start of each session the customer's monitor can display his own image permitting him to make any grooming adjustments he wishes and in doing so better put his mind at rest.

In addition to accepting a credit card or similar means as payment for system use as in one embodiment, the system could accept cash or any other payment means.

To reduce or eliminate problems with selling shoes and clothing on the system, industry standards on sizing could be established so that for example a medium mens shirt from one manufacturer will be the same as from another. One way would be to establish common sizing not for the clothing articles themselves but for the wearer. For example a medium man might have a chest measurement of 40 inches. In this way each manufacturer could size the garment to the standard figure which would provide for variance in designs. This method takes into account that some designs should fit more loosely than others. Alternately, the system could permit the customer to enter his essential dimensions which for a shirt would in part include his neck size while for pants would include his waist size. With this information the customer would select their items not by the item's size but by his own. Once a specific body measurement is entered the system could retain for future sizing by storing the data at the customer's location—permitting the customer to verify or alter in time as needed. Another alternative would be to provide regionally located facilities where customers may have their measurements taken for them to be used in future transactions. Such exhaustive and precise measurements may be recorded for the customer in writing or on some other form of storage that the customer could then feed into the system thereafter. These measurements could also include a recording and perhaps analysis of the customer's hair, eye, and skin tones as might be used at a future date to recommend clothing colors. For women these results could also be used to recommend makeup. Alternatively, the facility could transmit the measurement information to its central facility or a facility as selected by the customer should, for example, the measurement facility not be affiliated with a clothing provider. In this last instance the customer could be charged for the measurements taken but perhaps provided with a coupon to be applied to a subsequent purchase from a particular or list of particular providers. It is not always practical for a customer to visit the clothier from which he wishes to purchase, especially when there is great distance. With the above described methods a customer may purchase from any firm he chooses regardless of physical location, even in another country, and reduce or eliminate the vagaries and annoyances of fit.

Because in many instances providers of clothing will be matching a customer's exact sizing to a range of ready made goods they will need to round up or down to the next available size. As a failsafe the system should permit the customer to override automatic size selection. Perhaps a given customer would prefer his clothing to fit a bit too loose than a bit too tight, depending on the article and the difference between the customer's given measurement and the article's measurement. To avoid these complications manufacturers could plan their factories to automate or streamline the manufacture so that they may more nearly manufacture to a customer's exact measurements on demand and thereby reduce or eliminate the need for stocking inventory. Cutting and stitching machinery would then be processor controlled.

In providing services the system may also be used to deliver services, such as in the case of computer maintenance and support. The provider may by the system run periodic checks of the customer's equipment so as to identify and correct potential problems before they become critical. The customer could initiate such system checks or they could be initiated by the central facility at scheduled intervals.

In another embodiment the customer may having contacted a central facility select and play music or other entertainment of his choice, searching by artist/actor/title/director or other keyword. It would mimic radio except that the customer would be permitted to choose his own music/entertainment from a catalog of music available from some central facility. In this fashion the service could be provided by one central facility while one or more other central facilities store the music or other programming. The customer could do a search by artist and from a list of songs select 1 or more to play. He could also select a genre of music or entertainment from which to play songs chosen for him and while listening could interrupt to select his own. His picks could be other songs from artists already played or unrelated. He would have control of playback. Between every few songs or at selected intervals for other entertainment the customer would hear and see ads which could include public announcements or a prerecorded announcer giving information related to the performance. To aid in the proper selection of a commercial break which is computer selected, each performance could be encoded w/points at which a break would be least annoying/most appropriate at some predetermined time interval such as 10 minutes. While songs are playing customer would see ads on his monitor. Customer may then request more specific info on or purchase any product so advertised. He could also purchase the entertainment he is viewing or licensed goods related to.

Another approach would be more passive where the customer can build his own play list by making a selection of one or more genres such as with music or just pick a preset list. While listening he could select specific songs that he could add to his personal list which would then modify the existing list so that he would be assured of hearing more of a given song or artist in the future and could specify its frequency of repetition. Likewise, when tired of a given song he could remove it from his list—even while yet playing so as to skip the song.

In lieu of or in addition to advertisements, the customer could be charged for the entertainment presented by instance such as with an old time juke box. In this embodiment the entertainment product would not be downloaded for later playback at the control of the customer but instead remain in the possession of the central facility from where the customer may when he chooses replay. To affect this approach the software used to play the entertainment could be stored only with the central facility or at least its kernel portion (such as input/output) so that in the future the customer would have to contact the central facility to replay the music or performance. Playback functionality thus requires connection to the central facility.

Although the system 10 has been described with reference to financial services, the concept of the present invention as illustrated above is not so limited. It can be used to sell or assist in selling all goods and services comprising cars, boats, motorcycles, vacations, travel packages, investments, furniture, real estate, service contracts, product warranties, entertainment, financial services, and all other goods or services a customer might desire to remote customers whether or not financed or insured such as at a consumer goods store where customers use the system to select and transact their purchase.

In this sense the system serves as an expert system allowing the customer to obtain knowledgeable assistance from a central facility and its salesperson or representative. This may help customers of retail stores which sell large ticket items or complicated products which require or benefit from highly or moderately skilled sales people. In this instance the customer can be routed to an expert for the specific product or service he has an interest in. This responds to a common complaint that few stores have knowledgeable staff. The customer can then select and pay for his purchase at the terminal and take possession of his goods upon leaving. In using the equipment in this fashion the provider of the equipment can charge the customer a fee for use of the system and its services for which it can then provide the customer with a printed coupon, rebate or voucher for free goods or services, or an equivalent or partial discount should the customer purchase his goods or services at that remote location during an unlimited or limited future period of time. The system might also be used to convey or deliver cash, its equivalent, or scrip to the customer.

Such a system would be of great benefit to an employer in recruiting employees. An employment agency or head hunter might record interviews with a selection of employee candidates for presentation purposes permitting prospective employers to browse the catalogue of candidates in quickly narrowing and finalizing their recruiting search. Employers might also use the system for employee enrollment in payroll deduction programs for products like mutual funds.

An additional feature would permit customers to at any point in their session switch from a public or unsecured network to secured or private so that they may for example pay or complete transactions while keeping any information they present private.

One way a provider of goods or services might use the system would be as sort of an electronic tour of their company with the customer initially speaking with a greeter such as an operator to assist in their review of product and company information. The operator would then act as something of a tour guide. In this way the customer is able to electronically visit and tour the company, even be directed to an appropriate department, section of company, product, or employee. The system could also utilize system initiated playback of a simulated attendant. With this customers could be greeted and told of special offers without giving customers the impression they are being spied upon.

It is further contemplated that the system can be used not for merely selling and marketing products and services but for servicing and supporting those sales. Customers can then use the system to obtain account information or maintain their accounts.

As an additional use, the system can serve as an archive for date or document authentication. Documents can be transmitted from the user to a firm who documents origin and date while archiving.

While many of the enumerated applications of the system as herein described have been of an interactive or 1 to 1 nature, it is also contemplated that the system could in some cases broadcast information to a select group of users at the same time or all users such as in the case of breaking news or product updates.

As incentive for users to visit a given firm's database or file or as entertainment, providers might enable users to collectively participate in a game or contest where response of one user generates situation for other for which they are to respond. This could be a simulated war game or sport. One user could serve as the referee or game master for another user. Therefore, the action applied to a given user could be controlled by another user or generated based on the input of another user.

In the case of auction houses a number of remote facilities can be concurrently linked with one or more central facilities or auction houses so that groups of customers at each remote facility can participate in the actual auction for one or more distant central facilities or houses. In this fashion auction customers throughout the world can participate locally at auctions taking place throughout the world so that a customer in Saint Louis can participate and bid in an auction concurrently taking place in Hong Kong or France. In this particular embodiment each customer can have his own personal input device permitting him to personally enter his bid during the joint auction session and at the conclusion of a successful bid remit his payment. He can as well have a separate monitor or can share a large screen with some or all other participants such as at a local office of an auction house. Each customer can have a separate recording or printing device to provide the customer a record or receipt of any transaction he performs.

A number of terminals can be grouped to form an electronic shopping store permitting the customer to obtain desired information on the products of his choice while having access to highly knowledgeable representatives and can also record, print or otherwise, selected information for their later review. For this purpose the customer's monitor can display a tool or icon they will use to control the information to be recorded. Alternatively, the customer may use some other input means to enable him to control the information to be recorded. Remote facilities can even be portable so that for example they can be used at trade shows such as car shows permitting attendees to obtain more specific information about the products they desire and to execute their purchase and obtain financing. The customer is to communicate with central facilities comprising banks, credit unions and finance companies, a service company representing such companies, manufacturer's offices, or in general any provider from which a customer might wish assistance in facilitating a transaction. With a bank or other like institution a customer might transfer funds or arrange for payment. The method by which the transactions are facilitated reduces the costs associated with creating, marketing, administering, and selling these products and services, thereby making them more cost effective and affordable.

By providing that the central facility can be a service company the present invention has departed from the previous art. Typically when marketing their products in a traditional approach a company will use the assistance of a service company rather than directly sell or market their own products. The difficulty with the previous art is that they did not allow for a complement to the traditional marketing approach. In the case of deploying these systems specific corporate capabilities will be required. If companies have not felt comfortable in marketing their own products using long established methods and channels, they most certainly will not feel comfortable in using this system on their own. It is anticipated that many will instead demand the assistance of a third party who is more acquainted with the technologies involved and has developed expertise with them.

The foregoing objects are accomplished by a transaction system and method where having earlier established communications between the remote and central facilities the customer can use the electronic communications devices and computing equipment at the remote facility to contact a financial services company or some other central facility to facilitate a transaction, such as negotiate the purchase, lease, and contracting of financial services and/or other goods and services. In one embodiment of the invention a financial services company and its agents who will now be responsible for selling these products to the customers are located centrally and all or substantially all activities of the financial services companies or central facility and its agents are centralized in its state making those products subject at most to the laws of that state or sovereign and thereby meaningfully reduce or simplify regulatory constraints and streamline related compliance and business costs such as by having only one computer system used to support the selling and administrative process thus eliminating the need to provide this support including product presentation software at each distributed remote facility and in having to train only a single centrally located group of individuals who will act as the agents or representatives.

Previously these financial services companies sold their products through agents located at the site of the customer. The difficulty is that many of the products required that the agents be licensed to sell certain products such as investments and insurance. The difficulty with this is that a significant amount of training and expense was required to place these agents out there. High turnover rate of employees at one location could pose a real problem. The process of getting an agent licensed can itself take a year and each state regulated the licensing of agents within their state. In centralizing the agents we are able to reduce the licensing requirements since agents of the central facility can service customers from multiple states so that an agent at a central location say in Missouri could serve customers in theoretically up to all 50 states. So rather than have 50 different agents each serve a customer in each state we can have one agent serve as many as all 50 customers thereby reducing licensing bottlenecks and related expenses. The reduction in those expenses can then help these firms better manage their business expenses and in turn pass these savings on to their customers.

Although in one embodiment of the invention the customer speaks with only one representative at a time it is further anticipated that the customer can speak with multiple representatives from either the remote or central facilities at the same time as in a team sales approach. As it is anticipated that customers will speak a variety of languages it will be necessary for presentations and representatives thus provided to be based in the language of the customer; whether it be English, Spanish, French, German, Japanese, or any other desired language. This approach might include utilization of personnel at the remote facility to collectively assist the customer. Also, in one embodiment the financial services company or central facility will have no physical presence at the remote facility meaning they can not advertise in any fashion such as on radio, television, or in magazines in the state of the remote facility or by placing or storing product information such as sales materials or literature at the remote facility itself. This will require storing all product information at the central facility so that all activities including product information about these goods and services are then centralized at the central facility.

It should be understood however that certain information can be stored at remote facilities comprising directories of facilities for dialing purposes or a data base of providers of goods and services arranged by category of business or products offered such as in the Yellow Pages phone directory. In that sense an electronic phone book can be stored at the remote facility or instead upon pressing or utilizing the touch screen, keyboard or input device the customer can activate the system causing it to retrieve from a central facility a directory of goods and services available and thus permitting the customer to select another central facility such as from a displayed list or catalogue or some other input means and establish contact with it and thus have access to numerous central facilities and a myriad of goods and services. Listings may include audio clips to assist customers in the proper pronunciation of words or names. Users might be charged for this use such as each time they play a clip or as a subscribed service. Similarly, audio clips may be used in presentations and text objects so distributed such as in books or articles where customer may click on a word or phrase for pronunciation. Alternatively, customers may click on a word or phrase for a definition.

The present invention embodiment utilizing an electronic version of a Yellow Pages has deviated from the prior art in modifying these types of systems to fit with existing shopping patterns of the public. Rather than requiring the public to change their method of shopping for goods and services as the prior art requires, the present invention has with this embodiment adapted to existing modes of shopping. It has anticipated that the public's learned behavior is difficult to break and so has provided that the customer can shop according to existing patterns permitting them to shop by manufacturer, product, or marketer as one might if they were previously shopping for say a tire. In that event a customer can locate that specific tire either by its model name, its manufacturer, or the marketer through which he intends to purchase it. This approach is akin to a customer shopping through the White or Yellow Pages or by store or in a mall.

Additionally, customers can just browse through a selection of goods and services as though they were window shopping. To accomplish this the system can present a collection of products for those customers who do not have any specific need but are rather shopping as entertainment. This might include a group of unique products offered at special prices or terms. They could include limited edition merchandise or closeouts. As demonstrated, rather than requiring the public to adapt itself to a new method as did the prior art, this system has adapted itself to the public and current shopping behaviors.

While in general all or substantially all application software as in one embodiment will be located at each central facility, comprising programs which will prompt the customer for input, choices, or preferences so that the customer will contact the central facility and then indicate his choices or preferences, or simply browse the databases or files of goods and services; the system can also download certain software from the or a central facility to the remote facility such as to provide proper control and support or configuration for the customer by means of appropriate communications software or operating systems. This provides for the simple updating of any needed communications or other remote located software at the remote facility and ensures that each will be compliant with future standards of communications and protocol based upon changing needs and industry standards. Such downloaded software can be stored temporarily at the remote facility to be used only in the current session or can be retained for all or selected future sessions. The system can also quickly download a catalogue of desired or requested information to permit the customer to review leisurely while terminating the communications link to reduce connect charges or free utilization of the central facility's resources. The customer can then reestablish contact with the previous or a new representative and central facility when he is ready. To facilitate such a technique the remote or central facility can record the stopping point of the customer's last on-line presentation so that when contact is resumed an appropriate presentation continuing point can be ascertained.

An alternative is to allow the customer to enter any phone number he might wish to dial while accepting a credit card, debit card, or calling card where the customer is to pay or be charged for any phone, connection, or use charges that will be incurred. In this fashion the customer is to be charged for the use of the system, equipment or transmitting and receiving means. As with the phone company the system provider could charge the customer a monthly service charge. The customer could be charged for any system use or only for their use of an attendant at the central or remote facilities should they need assistance. However, it can be necessary or beneficial to not charge new customers for use of live attendants for a select period of time. Thereafter they will be treated as other customers. Otherwise, charging new customers for their use of attendants can discourage them from attempting the system's use. Once we get them accustomed to the system it will be easier to convince them to help themselves. Having charged the customer for use of a live attendant the central facility or the system can thereafter credit any subsequent purchase for those charges. This will promote customer loyalty, discouraging customers from using system resources while buying elsewhere. It should also be understood that while in many cases the attendant will be at the central facility from which the customer retrieves product information that the attendant may also be at another location such as where the provider is using a third party service company to provide the attendant. This might be referred to as a call or attendant center.

One way to manage access to the live attendants would be to assign a priority to customers (perhaps based on whether or not they are a current customer) to determine place in line when waiting for an attendant should there be more demand than availability. One might also consider frequency of use, last use, or volume of sales transacted. The provider could have a section for customers who belong to a special club or group and use of the live attendant could be one of the special perks for club membership.

Alternatively, the customer could be charged for any use, but more when they need human assistance, though charging for human assistance might best be phased in after starting out free. The benefit of this approach is that in offering live assistance customers are encouraged to use the system. This is sometimes necessary as not all customers will feel comfortable in using what they can perceive as a computer perhaps for fear of feeling or appearing inadequate. Having human assistance available will make these customers feel more secure and therefore willing to try the system. Yet in charging customers for the use of human assistance they are encouraged to help themselves thus permitting greater utilization of the representatives. This is perhaps an adaptation of animal or human behavior enticing the customer to first use the system and thereafter encourage them to help themselves.

As above, the system could thus provide a means to read credit cards comprising card swipe reader or any other approximate equivalent means and can as well be used to later tender payment for goods and services purchased. In this sense the system could be used as a sort of public telephone to transmit and obtain information about any goods and/or services the customer might desire from any location anywhere in the world.

A further variation in this theme is to instead charge the providers of goods for listing their products on the system. This could be in the form of a periodic flat fee or the providers could instead be charged for each incidence a customer requests their product information or is shown it involuntarily based on a customer's profile. Different rates can apply depending on whether a customer requests the information or is shown it involuntarily. To improve the reaction of the customer to an involuntary commercial the system might instead at the predetermined time offer a choice of commercials to the customer prompting them to choose which one they have most interest in and wish to see. One choice could even be a random selection if the customer wishes to be surprised. These commercials or unrequested product information could be shown before requested information or programming is presented.

This response or selection by the customer of the commercials to be shown serves two purposes. The first is that in voluntarily choosing which product the customer is to learn about, they are more apt to assume a positive attitude toward that product since they willingly chose it. Second, this selection by the customer could be used to build or update their customer profile.

In a similar fashion as the customer's profile can be used to determine which products they will view in commercials, this profile can also be used to determine which version of a provider's commercial a customer will see. It is a common practice in advertising to alter a commercial according to the demographics of the anticipated viewer. A commercial appearing on a country and western radio station will differ from that appearing on a classical music station. Having a profile for each user will permit advertisers to provide a message custom tailored to each specific customer profile.

To determine its corporate customer profile each provider of goods can use the system. Profiles of those customers who specifically request product information can be used by those providers to build general profiles of those customers who might have an interest or need in their goods. Thereafter those provider profiles can be used to help the system guide commercials to system users most likely to be interested in those goods. Commercials can then be shown to customers intermittently throughout the customer's session or at predetermined points such as when the customer is waiting for live assistance or in between queries.

One approach is to require that each customer watch one or more commercials to access entertainment programming.

Another approach to commercials is to credit a customer's account for each minute of commercials or product information he views or according to the amount of goods they purchase. In return the customer could be granted so many minutes of entertainment programming. One approach to this is similar to a traditional broadcast strategy where the customer passively sits back and watches assorted programming. Yet at anytime the customer can use an input device to request information on sponsors' products. A list is then presented to the customer of the various sponsors and the customer could then choose which ones he wants to see a presentation on. Each presentation may incorporate art into screens when more appropriate than images of goods or services, perhaps faint bitmaps, computer enhanced or altered.

Alternatively, a list of sponsors and their products could be collected from each program watched so that after the program has completed the customer could then review the list of sponsors and choose which commercials they will view. The products and sponsors can be tied into the programming but need not be related. The system could also build a list of chosen sponsors for each customer allowing them to at a later date go back and review the same or additional information on those products. As in the above embodiment a customer is only permitted so many minutes of entertainment programming for each minute of commercials. The result is quite different from present day television as customers are required to actually participate in the selection of the commercials they are to watch and can immediately obtain more specific information on those products they choose. Having made the decision for themselves, it is expected that customers will have more interest in the products of sponsors.

The application software at the central computerized facility in one embodiment includes a subroutine for charging customers for their use of personal assistance.

The application software at the central computerized facility in one embodiment includes a subroutine for charging customers for product information comprising each instance shown.

The application software at the central computerized facility in one embodiment includes a subroutine requiring customers to view a specified amount of product information in return for being granted a specified amount of use of the system.

The application software at the central computerized facility in one embodiment includes a subroutine providing the customer an electronic phone book containing a directory of providers and goods and services available.

The application software at the central computerized facility in one embodiment includes a subroutine which builds a general customer profile based upon customer's requests for information. This profile may be stored centrally or in a remote device for retrieval and may be updated by info requested of customer in sessions thereby keeping his personal profile current. With this profile advertisers and marketers will be better able to target their audience. Customers will still be able to access information on all goods and services and the information gathered from those free agent inquiries, that is inquiries made by users of the system, can be used to help each advertiser to determine its matching customer profile and thus the customers who will automatically see their ads at designated points in their sessions such as between queries and while waiting for attendants.

The application software of the central computerized facility in one embodiment includes a subroutine permitting a plurality of customers at different locations to view simultaneously the same presentation and to speak to each other during said presentation, the presentation being under the control of one of the customers.

Means are provided for control of the system to alternate between the individuals so that at times a first customer can control the presentation while at another time a second or other customer can assume control.

The central facility in one embodiment is a service company representing the provider of the goods or services.

A representative is located at the central computerized facility in one embodiment and that representative is an agent for the provider of the goods and services.

The customer computerized communications facility includes means for communicating with a number of competitive central computerized communications facilities.

The system in one embodiment wherein one facility is a retail sales store, and the other facility is a banking institution.

The system in one embodiment wherein one facility is an automobile company and the other facility is a bank.

The improved system in one embodiment wherein at least one central facility is an auction house.

The system in one embodiment also includes means enabling a customer to speak with a representative at at least one central facility.

It can now be readily seen that the system 10 of the present invention accomplishes centralizing the administration and selling of products and thereby meaningfully reduces the costs associated with creating, marketing, and administering these products and services. The system 10 also accomplishes consolidating management activities of the financial services products with the central office. The primary or only task of the retail sales location in one embodiment is to refer the customer to the equipment at the remote location. Hence, many responsibilities are centralized permitting better control and simplifying ongoing management. With the meaningful reduction in costs associated with developing and administering new products it is now possible, that is affordable, to develop a greater variety of products which are then more likely to fit the needs of specific customers. The third object is achieved as new product supporting materials, such as computer programs and other sales materials, are now centralized and it is less necessary to train an army of outside staff to sell and support the new products, giving the financial services company or other provider of goods and services more control as well on the sales process.

The foregoing description of embodiments of the invention has been presented for the purposes of illustration and description. It is not intended to be exhaustive or to limit the invention to the precise form disclosed. Many modifications and variations are possible in light of the above teaching. Such modifications and variations are deemed to be within the scope of this invention.

What is claimed is:

1. An improvement in the use of a communications network and associated apparatuses for providing marketing and/or sales information relating to goods and/or services comprising:
A computerized central communications facility of a first provider of goods and/or services, comprising at least one network communications device, at least one central processing unit, memory and/or external storage, and at least one file including information about goods and/or services; adapted to be connected in a communications network with:
at least one computerized central communications facility of a different provider, comprising at least one network communications device, at least one central processing unit, memory and/or external storage, and at least one file including information about goods and/or services, and;
with at least one computerized remote communications facility, comprising at least one network communications device, at least one central processing unit, memory and/or external storage, at least one display device, at least one speaker, and at least one input device;
wherein said computerized central communications facility of a first provider is configured to transmit at least a portion of the information about goods and/or services in at least one of its files from its memory and/or external storage using at least one of its network communications devices over said communications network to at least one of said computerized remote communications facilities, and;
wherein at least one of said computerized central communications facilities is configured to provide information from at least one file in its memory and/or external storage using at least one of its network communications devices over said communications network which enables at least one user via at least one input device of his computerized remote communications facility to select and contact at least one of said computerized central communications facilities of a different provider;
thus, the invention has improved the reliability, efficiency and competitiveness of such systems while expanding selection by reconfiguring the network and reshuffling its components to allow users to contact multiple providers of goods and/or services.

2. The network and associated apparatuses of claim 1, wherein at least one of said computerized central communications facilities is configured to transmit travel information from at least one file in its memory and/or external storage using at least one of its network communications devices over said communications network to least at least one of said computerized remote communications facilities.

3. The network and associated apparatuses of claim 1, wherein at least one of said computerized central communications facilities is configured to transmit vacation information from at least one file in its memory and/or external storage using at least one of its network communications devices over said communications network to least at least one of said computerized remote communications facilities.

4. The network and associated apparatuses of claim 1, wherein at least one of said computerized central communications facilities is configured to transmit real estate rental information from at least one file in its memory and/or external storage using at least one of its network communications devices over said communications network to least at least one of said computerized remote communications facilities.

5. The network and associated apparatuses of claim 1, wherein at least one of said computerized central communications facilities is configured to transmit auction information from at least one file in its memory and/or external storage using at least one of its network communications devices over said communications network, providing a user of at least one of said computerized remote communications facilities auctioning services and enabling said user to place an auction bid using at least one input device of said remote communications facility.

6. The network and associated apparatuses of claim 1, wherein at least one of said computerized central communications facilities is configured to transmit entertainment programming from at least one file in its memory and/or external storage using at least one of its network communications devices over said communications network, to at least one of said computerized remote communications facilities.

7. The network and associated apparatuses of claim 1, wherein at least one of said computerized central communications facilities is configured to use information about one or more users of said network and associated apparatuses stored in at least one file in memory and/or external storage to transmit over said communications network suggested products and/or services to at least one of said computerized remote communications facilities.

8. An improvement in the use of a communications network and associated apparatuses for marketing goods and/or services, comprising:
A computerized central communications facility of a first provider of goods and/or services, comprising at least one network communications device, at least one central processing unit, memory and/or external storage, and at least one file including information about goods and/or services; adapted to be connected in a communications network with:
at least one computerized central communications facility of a different provider, comprising at least one network communications device, at least one central processing unit, memory and/or external storage, and at least one file including information about goods and/or services, and;
with at least one computerized remote communications facility, comprising at least one network communications device, at least one central processing unit, memory and/or external storage, at least one display device, and at least one input device;
wherein at least one of said computerized central communications facilities is configured to provide information relating to goods and/or services in at least one file from memory and/or external storage using at least one network communications device over said communications network to at least one of said computerized remote communications facilities, enabling a user with at least one input device of said computerized remote communications facility to select and contact at least one computerized central communications facility of a different provider;
wherein at least one of said providers is charged or charges a fee to transmit information in at least one file from memory and/or external storage over said communications network which enables a user to select and contact at least one computerized central communications facility of a different provider;
thus, the invention has improved the reliability, efficiency and competitiveness of such systems while expanding selection by reconfiguring the network and reshuffling its components to allow users to contact multiple providers of goods and/or services.

9. The network and associated apparatuses of claim 8, wherein at least one of said computerized central communications facilities is configured to transmit operating system instructions from at least one of file in its memory and/or external storage using at least one of its network communications devices over said communications network to at least one of said computerized remote communications facilities.

10. The network and associated apparatuses of claim 8, wherein at least one of said computerized central communications facilities is configured to transmit communications instructions from at least one of its files in its memory and/or external storage using at least one of its network communications devices over said communications network to at least one of said computerized remote communications facilities.

11. The network and associated apparatuses of claim 8, wherein at least one of said computerized central communications facilities is configured to download application instructions from at least one of its files in its memory and/or external storage using at least one of its network communications devices over said communications network to at least one of said computerized remote communications facilities.

12. The network and associated apparatuses of claim 8, wherein at least one of said computerized central communications facilities is configured to transmit instructions from at least one of its files in its memory and/or external storage using at least one of its network communications devices over said communications network to at least one of said computerized remote communications facilities, enabling a user to access and/or browse marketing and/or sales information relating to goods and/or services from at least one computerized central communications facility of a different provider.

13. The network and associated apparatuses of claim 8, wherein at least one of said computerized central communications facilities is configured to transmit instructions from at least one file in its memory and/or external storage using at least one of its network communications devices over said communications network to at least one of said computerized remote communications facilities, to be retained for use by it in future sessions.

14. An improvement in the use of a communications network and associated apparatuses for marketing goods and/or services, comprising:
A computerized central communications facility of a first provider of goods and/or services, comprising at least one network communications device, at least one central processing unit, memory and/or external storage, and at least one file including information about goods and/or services; adapted to be connected in a communications network with:
at least one computerized central communications facility of a different provider, comprising at least one network communications device, at least one central processing unit, memory and/or external storage, and at least one file including information about goods and/or services, and;
with at least one computerized remote communications facility, comprising at least one network communications device, at least one central processing unit, memory and/or external storage, at least one speaker, and at least one input device;
wherein at least one of said computerized central communications facilities has at least one central processing unit configured to:
receive from at least one of said computerized remote communications facilities through at least one network communications device over said communications network a request to search, browse and/or access a file of said computerized central communications facility for information of interest;
enable a customer using said computerized remote communications facility to search, browse and/or access at least one file of said computerized central communications facility through at least one network communications device over said communications network for information of interest, and;
transmit information of interest from at least one file of said computerized central communications facility from memory and/or external storage through at least one network communications device over said communications network to said computerized remote communications facility;
wherein at least one of said computerized central communications facilities is configured to transmit to at least one of said computerized remote communications facilities from at least one file over at least one communications device and said communications network a list of at least one computerized central communications facility of a different provider, enabling a customer to select and contact said computerized central communications facility of a different provider to request information relating to goods and/or services, and;
wherein at least one central processing unit of at least one of said computerized central communications facilities is configured to transmit instructions from at least one of its files in its memory and/or external storage using at least one of its network communications devices over said communications network to at least one of said computerized remote communications facilities, said instructions used thereafter to present information of interest to a user;
thus, the invention has improved the reliability, efficiency and competitiveness of such systems while expanding selection by reconfiguring the network and reshuffling its components to allow users to contact multiple providers of goods and/or services.

15. The network and associated apparatuses of claim 14, wherein at least one of said computerized central and remote communications facilities is configured to record a presentation stopping point for at least one user in one or more files and/or in memory and/or external storage for future use.

16. The network and associated apparatuses of claim 14, wherein at least one of said computerized central communications facilities is configured to compile at least one profile based on one or more person's use of at least one of said computerized remote communications facilities.

17. The network and associated apparatuses of claim 14, wherein at least one of said computerized central communications facilities is operable to use a profile based on one or more person's use of said communications network and associated apparatuses to determine what goods and/or services information to show that and/or another a person.

18. The network and associated apparatuses of claim 14, wherein at least one of said computerized central communications facilities is operable to transmit an advertisement of a product and/or service from at least one file from memory and/or external storage using at least one network communications device over said communications network to at least one of said computerized remote communications facilities and enable a user to contact at least one computerized central communications facilities of another provider and obtain information about a product and/or service.

19. The network and associated apparatuses of claim 14, wherein at least one of said computerized central communications facilities is configured to be contacted through at least one communications device over said communications network by at least one of said computerized remote communications facilities, using an advertisement transmitted from at least one file in memory and/or external storage through said communications network by the computerized central communications facility of another provider.

20. The network and associated apparatuses of claim 14, wherein the provider of at least one of said computerized central communications facilities is compensated to transmit information on a product and/or service from at least one file in memory and/or external storage through said communications network to at least one of said computerized remote communications facilities.
